(19) United States
(12) Patent Application Publication
(10) Pub. No.: US 2016/0086518 A1
(43) Pub. Date: Mar. 24, 2016

(54) LABELING SYSTEM

(71) Applicant: Michael Sean Maher, Mt. Pleasant, SC (US)

(72) Inventor: Michael Sean Maher, Mt. Pleasant, SC (US)

(21) Appl. No.: 14/492,242

(22) Filed: Sep. 22, 2014

(51) Int. Cl. G09F 3/02

(52) U.S. Cl. CPC G09F 3/02; G09F 2003/0208; G09F 2003/0272

(57) ABSTRACT

A labeling system embeds a permanent label into a food container, such that the label may be reused for identifying container content, such as food. The label records at least one parameter about the contents of the container for a week long duration. The label includes spaces configured to receive removable marks from a marker. The parameter can include information pertinent to the identification, shelf life, and preparation time for the food, and a preparer identification. The parameters can also have each day of the week displayed. In this manner, the appropriate day can be marked to identify the date the food was stored in the container. Because of the greater duration covered by the parameters, the label does not have to be removed daily for marking new information thereto, and the need to remark over old markings on a label is minimized.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a labeling system for a container. More particularly, the invention relates to a labeling system that embeds a label in a food container to record information about the contents of the container for a duration.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a label can include a piece of paper, polymer, cloth, metal, or other material affixed to a container, on which is printed information about the product.

Typically, a label can have many uses including providing information on a product's origin, use, shelf-life and disposal, some or all of which may be governed by legislation such as that for food. It is known that food storage containers are widespread in use throughout restaurants and kitchens. Many products use low density polyethylene formed into plastic bags or plastic boxes, such as Tupperware®. Often, food storage inside a food container occurs in a cooler. The cooler holds a wide variety of foodstuffs and preserves them through the use of low temperatures. However, the contents of the food container must often be checked.

Typically, food safety is a scientific discipline describing handling, preparation, and storage of food in ways that prevent food borne illness. Food safety considerations include the origins of food including the practices relating to food labeling. Proper labeling of the food container can reduce risks of illnesses.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrates detailed perspective views of an exemplary labeling system, where FIG. 1A illustrates an exemplary container, and FIG. 1B illustrates an exemplary label embedded into the container, in accordance with an embodiment of the present invention; and

FIG. 2 illustrates a frontal view of an exemplary label having a plurality of spaces for identifying contents of the container, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of a labeling system for food containers that may be provided by preferred embodiments of the present invention. In one embodiment of the present invention, a labeling system may permanently embed a label with a food container, such that the label may be reused for identifying container content and the conditions of the container content. The label remains integrated into the container, such that repetitive removal and manipulation of the label relative to the container for remarking the label is not necessary. In essence, the label records parameters and information about the contents of the container without requiring manipulation of the label or remarking the same label. The label may also receive a removable mark through a removable ink marker. The marks may include at least one parameter containing information about a container content. Because of the permanent attachment between the label and the container, and the capacity to erase and rewrite marks on the label, the need for the removable labels known in the art is negated, or at least minimized.

In some embodiments, the container may include a plastic food container used to store food in a cooler. The label may include a plurality of spaces that receive removable marks from a marker. At least one parameter marked on the spaces may include information pertinent to the identification, shelf life, and preparation time for the food, and also include a preparer identification. In one embodiment, the at least one parameter includes information about the container content, including, expiration information, container content, and preparer information. Because the label is permanently embedded into the container and the marks on the label are removable, the label does not have to be removed daily for marking new information thereto. This capacity to repetitively use the label without physically detaching it from the container may help reduce costs and labor associated with replacing the label in every instance the container is changed.

In some embodiments, the label may embed between an inner portion and an outer portion of the container. The integration of the label into the container may help eliminate the need to repetitively replace the label after a duration, or after new container content is stored in the container. In some embodiments, the label may be configured to receive removable markings from a marker, such as a nonpermanent ink marker. The use of removable marking further enhances the use of the label by providing a clear space every time new markings must be written. Additionally, the label may include a plurality of spaces for marking at least one parameter pertinent to the container contents.

The plurality of spaces are configured to receive marking for at least one parameter. The parameter may include time and dates that can show the expiration times for the container content. In one embodiment, a week's worth of parameters may be marked into the spaces. After the week is completed, the marks may be removed by washing them off with a liquid. Thereafter, a subsequent week, with possibly different container contents, may be stored and have the parameters identified using the same label. This is accomplished without repetitively replacing labels or remarking the same printed label.

In an additional example of the parameters that can be marked and displayed from the plurality of spaces, at least one daily space identifies a date the container content is placed in said container; a content identification space identifies the container content, a preparation parameter space identifies a date and a time of preparation of the container content, a shelf life space identifies a shelf life duration for the container content; an expiration space identifies an expiration date for the container content; and a preparer identification space identifies a preparer of the container content.

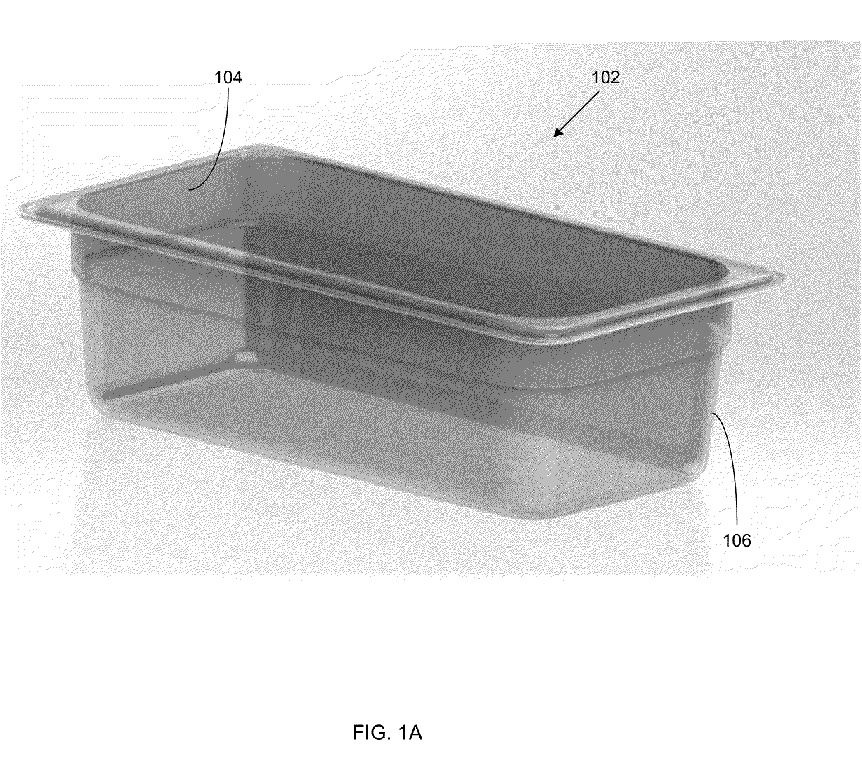

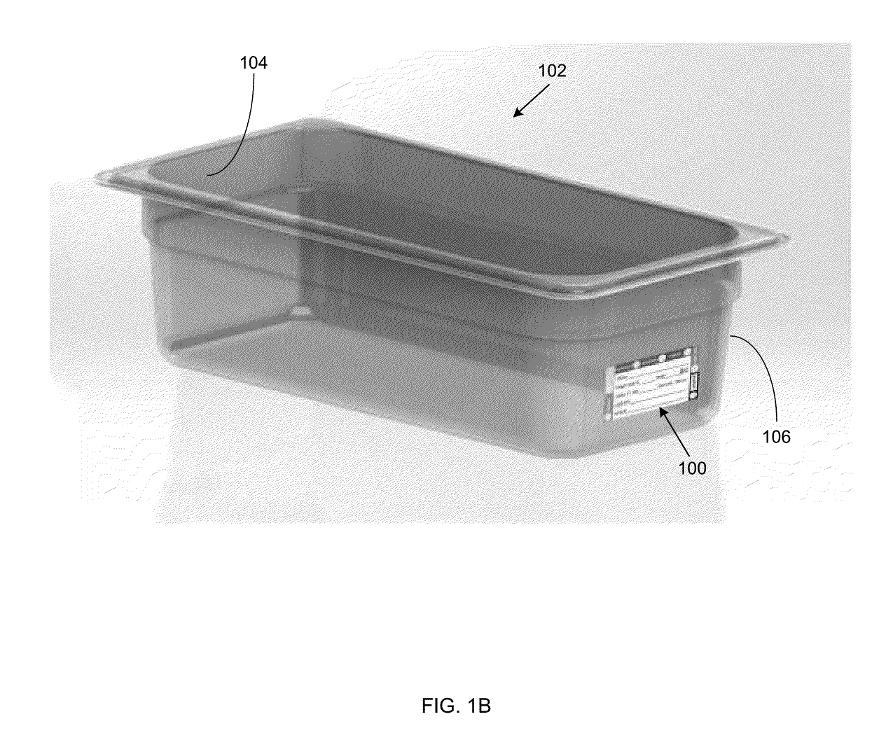

FIGS. 1A and 1B illustrates detailed perspective views of an exemplary labeling system, where FIG. 1A illustrates an exemplary container, and FIG. 1B illustrates an exemplary label embedded into the container, in accordance with an embodiment of the present invention. In the present invention, a labeling system 100 may join a label with a container 102. The label and the container may be permanently joined together. In this manner, the label may be reused for identifying and describing different container contents every time a new container content is added, or after a predetermined duration has passed. The label may also receive a removable mark through a removable ink marker. The marks may include at least one parameter containing information about a container content. Because of the permanent attachment between the label and the container, and the capacity to erase and rewrite marks on the label, the need for the removable labels known in the art is negated, or at least minimized.

Suitable materials for the label may include, without limitation, paper, polymer, cloth, metal. In some embodiments, the label may include a planar member having a surface receptive to receiving removable marks from a marker. The label may have various shapes, including, without limitation, rectangle, square, circle, oval, and pyramid.

The labeling system may permanently embed a label with a food container, such that the label may be reused for identifying container content and the conditions of the container content. The label remains integrated into the container, such that repetitive removal and manipulation of the label relative to the container for remarking the label is not necessary. In essence, the label records parameters and information about the contents of the container for a duration without requiring manipulation of the label or remarking the same label. The label, thus, removes the need for the removable labels known in the art.

Those skilled in the art will recognize that the labels known in the art utilize an adhesive that sticks to the container. The label must be peeled off for every change in container content or after a predetermined duration. This leaves adhesive on the container, which can contain bacteria. Additionally, the labels known in the art can receive a single marking. Additional markings often have include crossing out the prior marking and writing on the edges. This can cause confusion. Furthermore, many organizations have a Best Operating Practice, requiring containers to be changed out every twenty four hours. This requires repetitive changing of labels, which may cause errors in labeling.

In some embodiments, the label may embed between an inner portion 104 and an outer portion 106 of the container. The integration of the label into the container may help eliminate the need to repetitively replace the label after a duration, or after each new container content is stored in the container. In some embodiments, the label may record at least one parameter about the container contents for a duration of time, such as one week. The container may include a plastic food container used to store food in a cooler. However, other suitable materials may include, without limitation, NSF plastic, polyurethane, polyethylene, clear polymers, glass, and fiberglass.

The label may include a plurality of spaces that receive removable marks from a marker. At least one parameter marked on the spaces may include information pertinent to the identification, shelf life, and preparation time for the food, and also include a preparer identification. In some embodiments, the plurality of spaces are configured to receive marking for parameters. The parameters include time and dates that can show the expiration times for the container content.

In one embodiment, a week's worth of parameters may be marked into the spaces. After the week is completed, the marks may be removed by washing them off with a liquid. Thereafter, a subsequent week, with possibly different container contents, may be stored and have the parameters identified using the same label. This is accomplished without repetitively replacing labels or remarking the same printed label. The at least one parameter includes information about the container in a time prior or weekly period. Because of the greater time period and other information marked into the spaces, the label does not have to be removed daily for marking new information thereto. This capacity to repetitively use the label without physically detaching it from the container may help reduce costs and labor associated with replacing the label in every instance the container is changed.

Those skilled in the art, in light of the present teachings, will recognize that health departments or organizational Best Operating Practices require restaurants to label food contained in food containers. The labeling identifies the freshness, quality assurance, and safety of the contained food. In this manner, cross contamination is inhibited, and the expected shelf life of the food before expiration can be determined by food preparers and health department inspectors. However, the health department may requires that the label must be renewed each day by removing the expired marked label and replacing it with a new marked label. In one possible example, the time of preparation would read 48 hours in the new label to replace the expired label showing 24 hours. The labels known in the art, which are used for this process, can be difficult to remove from the container, and become unreadable in high moisture areas, such as walk-in food coolers and freezers. While the labels known in the art may be dissolvable, they are still difficult to remove and leave a residue on the container that is considered a violation of state health codes. The labeling system of the present invention may help resolve these problems by permanently embedding into the container and providing spaces to record information about the food with a removable marker.

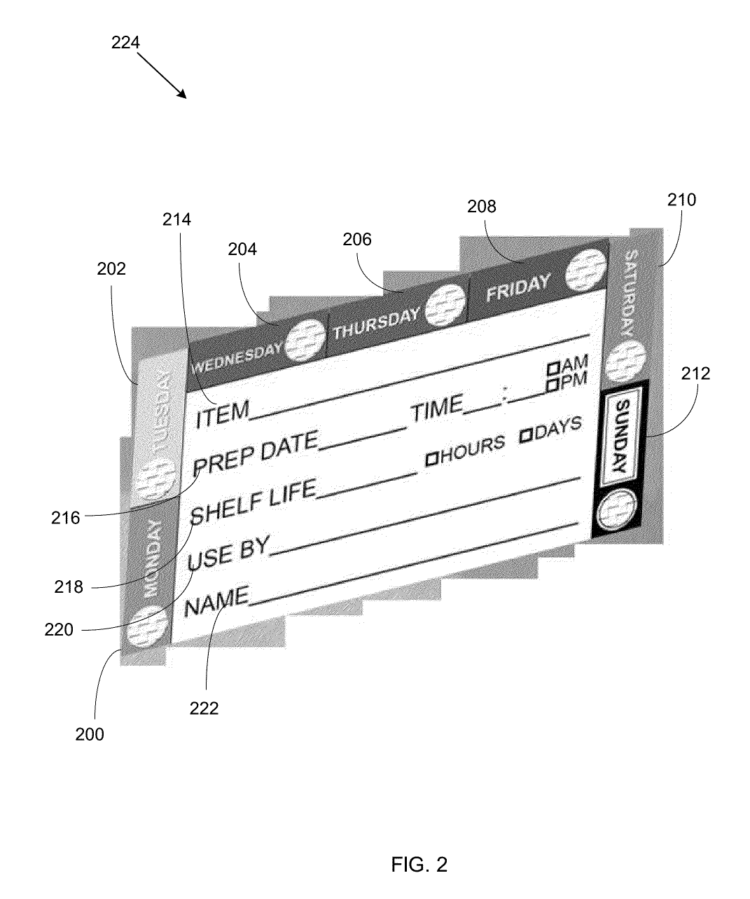

FIG. 2 illustrates a frontal view of an exemplary label having a plurality of spaces for identifying contents of the container, in accordance with an embodiment of the present invention. In the present invention, a label 224 may include a planar member configured to receive marks from a marker, and display marks from an at least partially transparent container. The label may include a plurality of spaces configured to receive a mark from the marker. The label may be configured to receive removable markings from a marker, such as a nonpermanent ink marker. However, in other embodiments, the marks may include a removable ink, a crayon, chalk, detachable text and numbers, and any partially removable mark. The use of removable marking further enhances the use of the label by providing a clear space every time new markings must be written.

In some embodiments, the plurality of spaces comprises at least one parameter pertinent to the container contents. The spaces may provide an area to mark the time, week, duration, contents, and food preparer's information. In one embodiment, a week's worth of parameters may be marked into the spaces. After the week is completed, the marks may be removed by washing them off with a liquid. Thereafter, a subsequent week, with possibly different container contents, may be stored and have the parameters identified using the same label. However, in other embodiments, the parameters may cover anywhere from a day, a month, or longer.

In some embodiments, the at least one parameter may include at least one daily space that identifies the date that the container content is placed in the container and/or cooler. The at least one daily space may also be used for recording other important information about the container content. In one embodiment, the at least one daily space includes a Monday space 200, a Tuesday space 202, a Wednesday space 204, a Thursday space 206, a Friday space 208, a Saturday space 210, and a Sunday space 212. The appropriate space may be checked or marked as desired to indicate the day of the week that the container content was placed in the container. In this manner, the freshness of the container content, such as meat, seafood, or fruit, may be visually determined at a glance.

In some embodiments, the at least one parameter may include a content identification space 214 for identifying the container content. The content identification space may include an item marking. For example, without limitation, a type of food, such as chicken breasts can be marked to differentiate from chicken thighs in a different container. In some embodiments, the at least one parameter may include a preparation parameter space 216 for identifying a date and a time of preparation of the container content. A checkbox may be used to distinguish between the date and time, and a space for marking numerals may also be available.

In some embodiments, the at least one parameter may include a shelf life space 218 for identifying a shelf life duration for the container content. The shelf life space may include a numeral, an hour checkbox, and a day checkbox for distinguishing the exact date and/or time that the shelf life of the container content has terminated. In some embodiments, the at least one parameter may include an expiration space 220 for identifying an expiration date for said container content. In one embodiment, the expiration space may have a use by identifier to indicate the last date possible for use of the container content. In some embodiments, the at least one parameter may include a preparer identification space 222 for identifying a preparer of said container content. The preparer space may have a user identifier to mark a preparer's name with the marker. In this manner, the preparer may identified if questions arise about the container content.

In one alternative embodiment, the label may be magnetic, so as to attach to stainless steel containers. In yet another alternative embodiment, the at least one daily space may be comprised of a monthly calendar. In yet another alternative embodiment, the label may be digital and remotely marled upon. In yet another alternative embodiment, the system may be utilized to label nonfood perishable items.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a labeling system that embeds a permanent label in a food container to record information about the contents of the container for a duration according to the present invention will be apparent to those skilled in the art. Various aspects of the invention have been described above by way of illustration, and the specific embodiments disclosed are not intended to limit the invention to the particular forms disclosed. The particular implementation of the labeling system that embeds a permanent label in a food container to record information about the contents of the container for a duration may vary depending upon the particular context or application. By way of example, and not limitation, the labeling system that embeds a permanent label in a food container to record information about the contents of the container for a duration described in the foregoing were principally directed to a labeling system for food storage containers that permanently embeds within the container and includes removable marking spaces for a week's duration implementations; however, similar techniques may instead be applied to storage of items other than food for greater durations than a week, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a label configured to join with a container,
said label comprising a plurality of spaces configured to receive a mark for identifying at least one parameter,
said mark configured to be at least partially removable from said plurality of spaces,
said at least one parameter comprising information about a content of said container.

2. The system of claim 1, in which said container comprises a plastic food container.

3. The system of claim 2, wherein said container is configured to store a container content in a cooler, said container content comprising a food.

4. The system of claim 3, wherein said label is configured to permanently embed between an outer portion and an inner portion of said container.

5. The system of claim 4, in which said label comprises a planar member configured to receive a removable ink.

6. The system of claim 5, in which said at least one parameter comprises at least one daily space for identifying a date said container content is placed in said container.

7. The system of claim 6, in which said at least one daily space comprises a Monday space, a Tuesday space, a Wednesday space, a Thursday space, a Friday space, a Saturday space, and a Sunday space.

8. The system of claim 7, in which said at least one parameter comprises a content identification space for identifying said container content.

9. The system of claim 8, in which said content identification space comprises an item marking.

10. The system of claim 9, in which said at least one parameter comprises a preparation parameter space for identifying said date and a time of preparation of said container content.

11. The system of claim 10, in which said preparation parameter space comprises a preparation date and a preparation time.

12. The system of claim 11, in which said at least one parameter comprises a shelf life space for identifying a shelf life duration for said container content.

13. The system of claim 12, in which said shelf life space comprises a numeral, an hour checkbox, and a day checkbox.

14. The system of claim 13, in which said plurality of spaces comprises an expiration space for identifying an expiration date for said container content.

15. The system of claim 14, in which said expiration space comprises a use by identifier.

16. The system of claim 15, in which said plurality of spaces comprises a preparer identification space for identifying a preparer of said container content.

17. The system of claim 16, in which said preparer identification space comprises a user identifier.

18. The system of claim 17, in which said system comprises a removable ink marker configured to mark on the plurality of spaces.

19. A system comprising:
means for placing a container content in a container;
means for at least partially embedding as label between an outer portion and an inner portion of said container;
means for marking a removable mark in a plurality of spaces;
means for marking in at least one daily space for identifying a date said container content is placed in said container;
means for marking a content identification space for identifying said container content;
means for marking a preparation parameter space for identifying a date and a time of preparation of said container content;
means for marking a shelf life space for identifying a shelf life duration for said container content;
means for marking an expiration space for identifying an expiration date for said container content; and
means for marking a preparer identification space for identifying a preparer of said container content; and
means for remarking said label after a predetermined duration or change in container content.

20. A system consisting of:
a label configured to permanently embed into a container, said label comprising a planar member configured to display information about a container content, said container further comprising a food container,
said label comprising a plurality of spaces configured to receive a removable mark for identifying at least one parameter about said container content, said mark configured to be at least partially removable from said plurality of spaces,
said at least one parameter comprising at least one daily space for identifying a date said container content is placed in said container, said at least one parameter further comprising a content identification space for identifying said container content, said at least one parameter further comprising a preparation parameter space for identifying a date and a time of preparation of said container content, said at least one parameter further comprising a shelf life space for identifying a shelf life duration for said container content, said at least one parameter further comprising an expiration space for identifying an expiration date for said container content, said at least one parameter further comprising a preparer identification space for identifying a preparer of said container content.
